(19) United States
(12) Patent Application Publication
(10) Pub. No.: US 2025/0348926 A1
(43) Pub. Date: Nov. 13, 2025

(54) TOLL-FREE SUBSCRIPTION AND RENTAL SERVICE SYSTEM

(71) Applicant: LIFE LABO CO., LTD., Tokyo (JP)

(72) Inventor: Takashi AKIKUSA, Tokyo (JP)

(21) Appl. No.: 18/850,539

(22) PCT Filed: Mar. 30, 2022
(86) PCT No.: PCT/JP2022/015858

§ 371 Date: May 28, 2025

(51) Int. Cl. G06Q 30/0645; G06Q 20/06; G06Q 30/0208

(52) U.S. Cl. CPC G06Q 30/0645; G06Q 20/065; G06Q 30/0208

(57) ABSTRACT

A toll-free subscription and rental service system includes a terminal device and a business operator server. The terminal device includes a deposit point determination unit that determines deposit points to be deposited to the business operator based on the total points purchased; a deposit period designation unit that designates the deposit period for depositing the deposit points; and a provided service selection unit that selects a desired service from at least one available toll-free services, which have been determined based on the deposit points and the deposit period. The business operator server comprises a provided service determination unit that determines an available toll-free service based on the deposit points and deposit period; a period management unit that manages the period of the service, which is used by the user of the terminal device; and a memory unit that stores user information to which the service is provided.

### CROSS-REFERENCE TO RELATED APPLICATIONS

This application is a national phase application of International Application No. PCT/JP2022/015858 filed Mar. 30, 2022, the contents of which being incorporated by reference in its entirety herein.

### TECHNICAL FIELD

This disclosure relates to a toll-free subscription and rental service system, wherein the system provides users with digital content distribution services, rental services such as movable and immovable properties, and the subscription services that are normally provided with a charge.

### BACKGROUND

Recently, a content distribution system that distributes digital content such as music, videos, and games from a server device to a terminal device such as a smartphone or a PC via communications such as the Internet, have become popular. Those content are available in the terminal device. In this case, subscriptions (also known as periodic subscriptions or continuous purchases) have been widely and commonly used, wherein a fee is paid for the right to use products or services for a certain period of time, rather than owning or purchasing interesting products or services.

For example, as content rentals, a system has been disclosed for managing rentals of video content that can be viewed on one or more types of viewing devices. Further, as a movable property rental system, a bicycle rental system has been disclosed, wherein the manager can better understand the condition of the bicycles, thereby improving the service in this system.

### BRIEF SUMMARY

The subscription business model described above has the advantage that users can purchase only the content that interests them. However, in the case of fixed-price purchases and so on, there are problems in that users may continue to subscribe to unnecessary services, or may prolong the charges for content that is no longer needed, due to lack of awareness.

On the other hand, a subscription is a business model in which profits are generated according to the number of subscribers. For this reason, it is difficult for rental service providers, such as start-up companies, that lack funds to continue providing attractive content distributions and rental services. This results in a barrier for them to enter a rental business.

The present disclosure has been made in view of the above-mentioned problems and has an objective to provide a toll-free subscription and rental service system that can appropriately prevent users from being charged for services that are no longer necessary, and that allow users to receive these services free of charge, in terms of subscription services for consumer goods such as food and drink for a fixed period at a fixed price, or content distributions and other rental services for movable properties and real estates.

In order to achieve the above-mentioned purpose, this disclosure is a toll-free subscription and rental service system comprising: a terminal device that is owned by a user who receives the subscription and rental service; and a business operator server that is connected to the terminal device via network and is managed by a business operator who provides the subscription and rental service to the user for free, wherein the terminal device comprising: a transmitting/receiving unit that transmits and receives data with the business operator server: a point purchasing unit that purchases points to be used when receiving the subscription and rental service: a deposit point determination unit that determines deposit points to be deposited to the business operator, which provides the subscription and rental service based on the total points purchased via the point purchasing unit: a deposit period designation unit that designates the deposit period for depositing the deposit points; and a provided service selection unit that selects a desired subscription and rental service from at least one available toll-free subscription and rental services, which have been determined based on the deposit points and the deposit period, wherein the business operator server comprising: a communication unit that communicates with the terminal device: a deposit point storage unit that stores deposit points deposited from the terminal device via the communication unit: a provided service determination unit that determines an available toll-free subscription and rental service based on the deposit points and the deposit period in a case when receiving the deposit points and the deposit period from the terminal device via the communication unit: a period management unit that manages the period of the subscription and rental service, which is used by the user of the terminal device; and a memory unit that memorizes user information to which the subscription and rental service is provided.

As for this toll-free subscription and rental service system, in some embodiments, the period management unit returns the deposit points, which correspond to a user and have been deposited in the deposit point storage unit, to the terminal device, in a case when the period of the subscription and rental service used by the user has ended.

As for this toll-free subscription and rental service system, in some embodiments, the memory unit memorizes information relating to name, password, the deposit points, provided services, and the deposit period of each user who uses the toll-free subscription and rental service.

As for this toll-free subscription and rental service system, in some embodiments, the deposit point is a point or virtual currency that is provided by the business operator to the user of the terminal device.

As for this toll-free subscription and rental service system, in some embodiments, the rental service includes a digital content distribution service and a rental service such as movable and immovable properties; and the subscription service includes the offering of a designated service or designated consumer goods in exchange for paying a fixed amount at a fixed interval.

In order to solve the above-mentioned problems, this disclosure is a program that is used for a terminal device, which is owned by a user who receives a toll-free subscription and rental service, the program comprising: a transmitting/receiving step of transmitting and receiving data with a business operator server that provides the subscription and rental service: a point purchasing step of purchasing points to be used when receiving the subscription and rental service: a deposit point determination step of determining deposit points to be deposited to the business operator, which provides the rental service based on the total points purchased via the point purchasing step: a deposit period designation step of designating the deposit period for depositing the deposit points; and a provided service selection step of selecting a desired subscription and rental service from at least one available toll-free subscription and rental services, which have been determined based on the deposit points and the deposit period.

In order to solve the above-mentioned problems, this disclosure is a program that is used for a device managed by a business operator, which provides a toll-free subscription and rental service to a user, while connecting with a terminal device via network, the program comprising: a communication step of communicating with the terminal device: a deposit point storage step of storing deposit points deposited from the terminal device in the communication step: a provided service determination step of determining an available toll-free subscription and rental service based on the deposit points and the deposit period, in a case when receiving the deposit points and the deposit period from the terminal device in the communication step: a period management step of managing the period of the subscription and rental service, which is used by the user of the terminal device; and a memory step of memorizing user information to which the subscription and rental service is provided.

In order to solve the above-mentioned problems, this disclosure is a terminal device that is owned by a user who receives a subscription and rental service, and that is connected to a business operator server, which is managed by a business operator who provides the subscription and rental service to the user for free, the terminal device comprising: a transmitting/receiving unit that transmits and receives data with the business operator server: a point purchasing unit that purchases points to be used when receiving the subscription and rental service: a deposit point determination unit that determines deposit points to be deposited to the business operator, which provides the subscription and rental service based on the total points purchased via the point purchasing unit: a deposit period designation unit that designates the deposit period for depositing the deposit points; and a provided service selection unit that selects a desired subscription and rental service from at least one available toll-free subscription and rental services, which have been determined based on the deposit points and the deposit period.

In order to solve the above-mentioned problems, this disclosure is a business operator server that is connected to a terminal device, which is owned by a user who receives a subscription and rental service, via network and is managed by a business operator who provides the subscription and rental service to the user for free, the business operator server comprising: a communication unit that communicates with the terminal device: a deposit point storage unit that stores deposit points deposited from the terminal device via the communication unit: a provided service determination unit that determines an available toll-free subscription and rental service based on the deposit points and the deposit period in a case when receiving the deposit points and the deposit period from the terminal device via the communication unit: a period management unit that manages the period of the subscription and rental service, which is used by the user of the terminal device; and a memory unit that memorizes user information to which the subscription and rental service is provided.

This disclosure is a toll-free subscription and rental service system comprising: a terminal device that is owned by a user who receives the subscription and rental service; and a business operator server that is connected to the terminal device via network and is managed by a business operator who provides the subscription and rental service to the user for free. The terminal device comprises: a transmitting/receiving unit that transmits and receives data with the business operator server: a point purchasing unit that purchases points to be used when receiving the subscription and rental service: a deposit point determination unit that determines deposit points to be deposited to the business operator, which provides the subscription and rental service based on the total points purchased via the point purchasing unit: a deposit period designation unit that designates the deposit period for depositing the deposit points; and a provided service selection unit that selects a desired subscription and rental service from at least one available toll-free subscription and rental services, which have been determined based on the deposit points and the deposit period. The business operator server comprises: a communication unit that communicates with the terminal device: a deposit point storage unit that stores deposit points deposited from the terminal device via the communication unit: a provided service determination unit that determines an available toll-free subscription and rental service based on the deposit points and deposit period in a case when receiving the deposit points and deposit period from the terminal device via the communication unit: a period management unit that manages the period of the subscription and rental service, which is used by the user of the terminal device; and a memory unit that memorizes user information to which the subscription and rental service is provided. With this configuration, in terms of content distributions and other movable properties and real estate rental services, the toll-free system appropriately prevents users from being charged for services that are no longer needed and can provide these rental services free of charge. Furthermore, if a company plans to popularize points or virtual currency that are issued by the company, the company could collaborate with paid subscription services offered by other companies. And then, the company asks users of those services to purchase and deposit points issued by the company. As a result, the company can make the previously paid service free of charge, thereby benefiting users and hopefully increasing awareness and popularity of the company's currency.

### BRIEF DESCRIPTION OF DRA WINGS

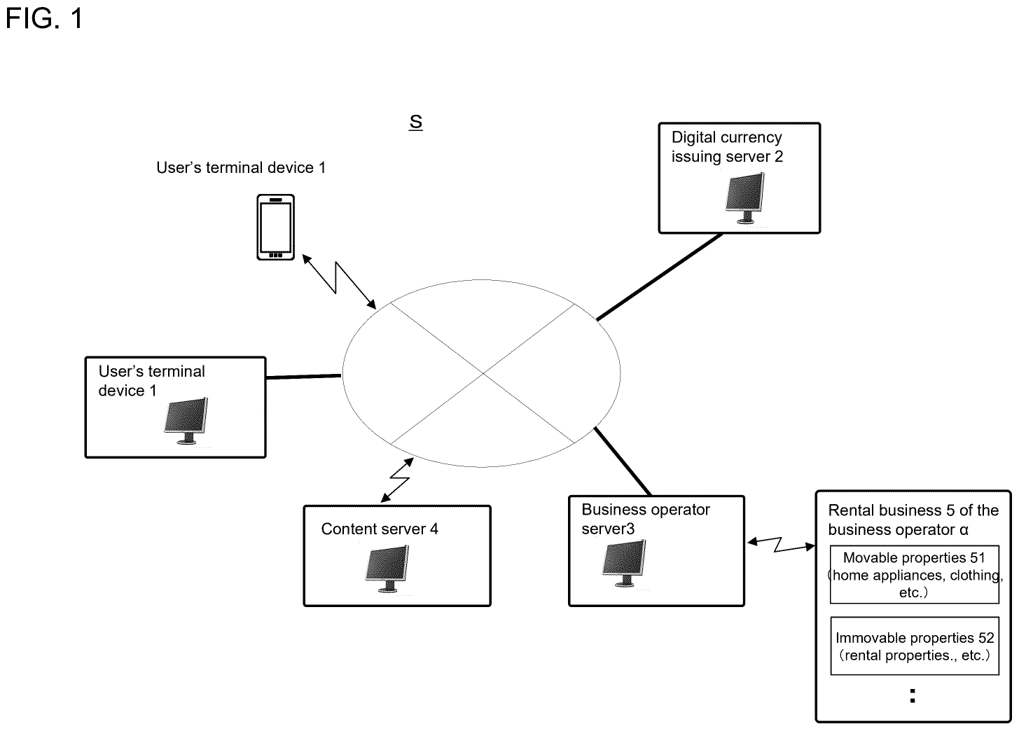

FIG. 1 is a whole configuration diagram showing a toll-free subscription and rental service system according to an embodiment of this disclosure.

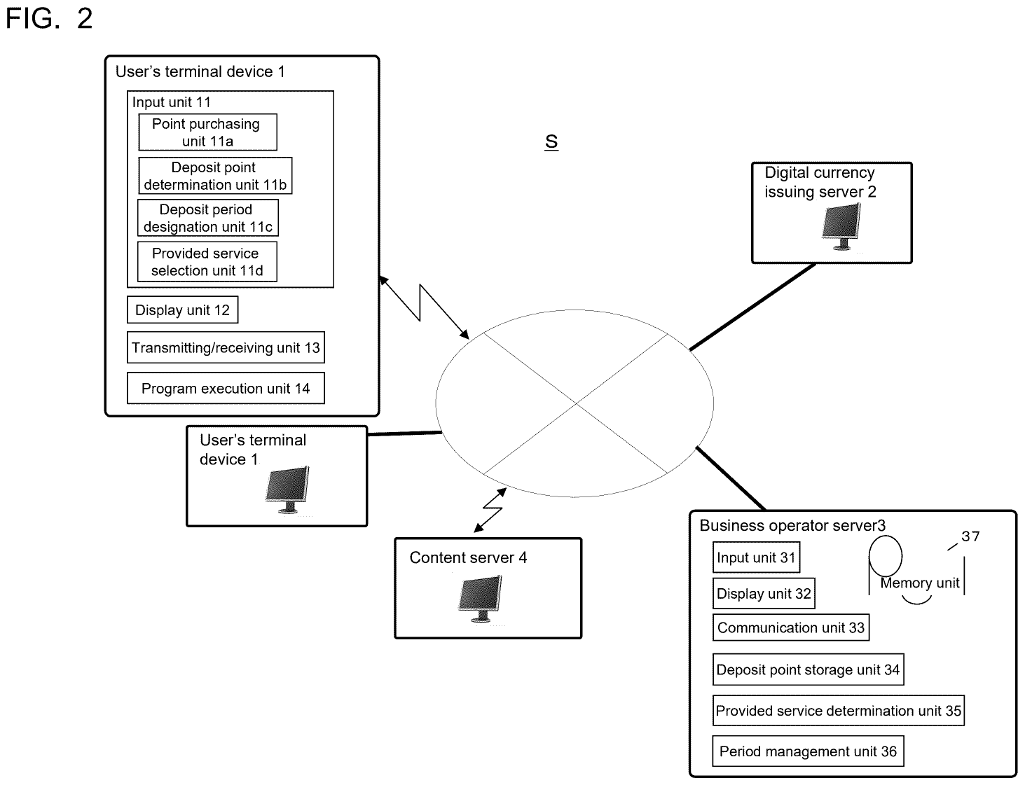

FIG. 2 is a functional block diagram showing the toll-free subscription and rental service system.

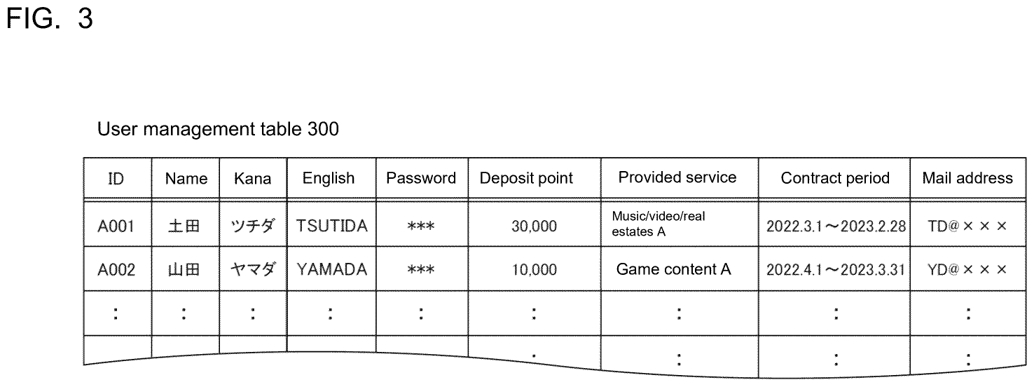

FIG. 3 is a diagram showing a user management table memorized in a business operator server, which is composed of the toll-free subscription and rental service system.

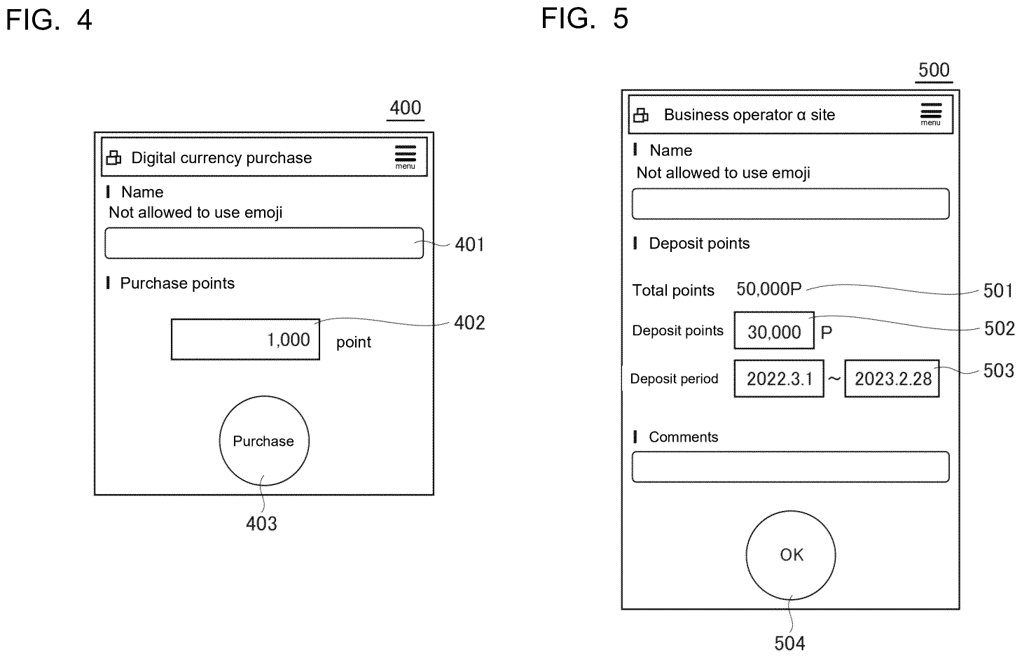

FIG. 4 is a diagram showing an example of a screen displayed on the display unit of the terminal device, which is composed of the toll-free subscription and rental service system.

FIG. 5 is a diagram showing an example of a screen displayed on the display unit of the terminal device.

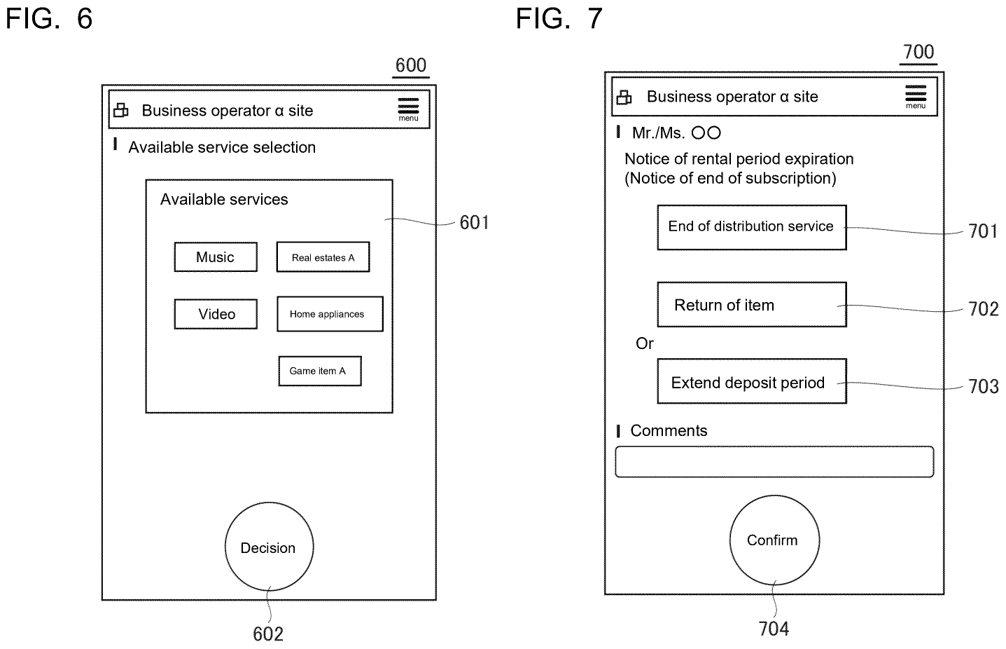

FIG. 6 is a diagram showing an example of a screen displayed on the display unit of the terminal device.

FIG. 7 is a diagram showing an example of a screen displayed on the display unit of the terminal device.

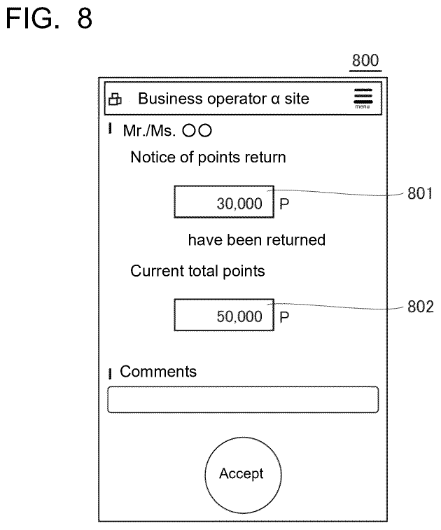

FIG. 8 is a diagram showing an example of a screen displayed on the display unit of the terminal device.

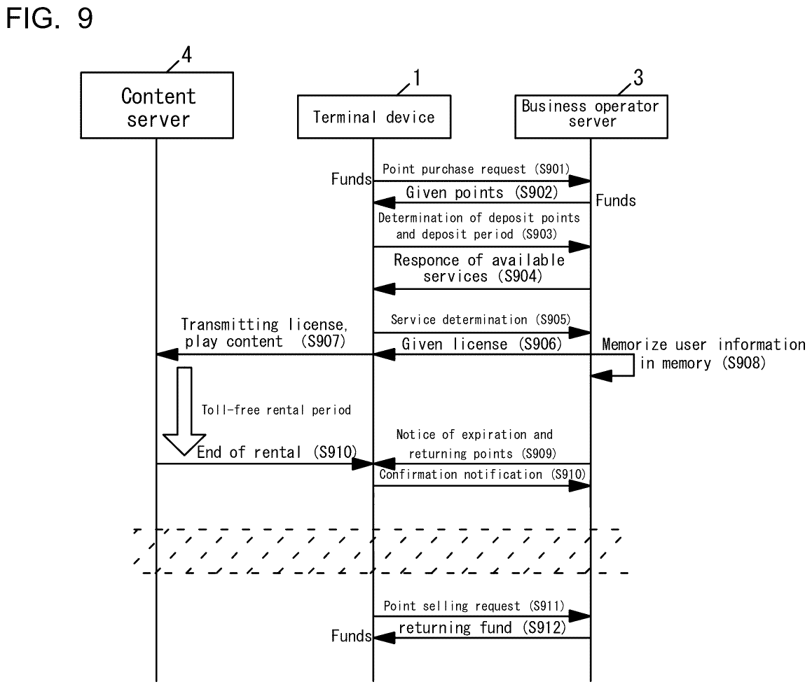

FIG. 9 is a sequence diagram showing an example of flows of the toll-free subscription and rental service system.

### DETAILED DESCRIPTION

### Embodiment

A toll-free subscription and rental service system (hereinafter referred to as a toll-free system) according to an embodiment of the present disclosure will be described with reference to the figures. This toll-free system can provide users with subscription services for digital distribution content such as music, videos, and games, rental services for home appliances, movable properties such as clothing and cars, and real estate such as rental apartments and private lodgings free of charge while making it easier for a business operator to raise funds. In this specification, the term “subscription” or “rental service” is synonymous with at least one of a subscription and a rental service. The subscription service also includes the offering of designated services or designated consumer goods in exchange for paying a fixed amount at a fixed interval.

### <Overall System Diagram>

First, the overall configuration of the toll-free system according to the present embodiment will be described with reference to FIG. 1. In this toll-free system S, a terminal device 1 owned by a user, a digital currency issuing server 2, a business operator server 3 managed by a business operator a which operates a rental business etc., and a content server 4 which provides digital content such as music, video, and games, are connected via a wide area network such as the Internet.

The terminal device 1 is a communication terminal such as a smartphone or a personal computer owned by the user of the toll-free system S. The terminal device 1 establishes a communication session with the digital currency issuing server 2, the business operator server 3, and the content server 4 based on a specified protocol, and transmits and receives data and files related to free rental contracts, etc. The terminal device 1 displays a website and dedicated application screen, which are provided by the business operator a. This display is, for example, a screen that uses a GUI (Graphical User Interface) for a toll-free service contract, as shown in FIG. 4 to FIG. 8 described below.

The digital currency issuing server 2 is a server device that issues and manages a digital currency such as a virtual currency. The digital currency issuing server 2 is operated by a dedicated sales outlet, where the digital currency can be purchased based on Japanese yen, and the purchased digital currency is basically deposited to the dedicated sales outlet.

The business operator server 3 is a server device managed by the business operator a that provides the toll-free system S and manages the deposit points, free services, service period, and usage rights of users (rental members). In addition, the business operator server 3 is a server that distributes a usage license for the content server 4 and the like to the terminal device 1. In this embodiment, as shown in FIG. 1, the business operator a basically operates a rental business 5 of movable and immovable properties other than digital contents, and manages movable properties 51 such as home appliances, clothing, cars, and books, and immovable properties 52 such as rental properties.

In this embodiment, the content server 4 is a server that is managed by the business operator a and distributes digital contents to the terminal device 1. The terminal device 1 uses a license issued by the business operator server 3 based on the contract details and plays content such as music, video, and games distributed from the content server 4. Herein, the content server 4 does not necessarily have to be operated by the business operator a, and may be a content distribution server 4 operated by another company that cooperates with the business operator a.

### <Functional Block Diagram>

Next, the functional blocks of each processing unit of the toll-free system S according to the present embodiment will be described with reference to FIG. 2.

The terminal device 1 comprises at least an input unit 11 using a keyboard function, a display unit 12 such as an LCD screen, a transmitting/receiving unit 13 for transmitting and receiving data between the business operator server 3 and the content server 4, and a program execution unit 14 for executing a web browser or a dedicated application for receiving the rental service of the business operator a. A user of the terminal device 1 refers to the screen displayed on the display unit 12 and uses the input unit 11 to purchase points from the business operator a or the digital currency issuing server 2. Then, the user can receive free access to desired services based on these points. In addition, optionally, the points used in the toll-free system S are digital currencies such as Bitcoin (registered trademark) and Ethereum (registered trademark), which can basically be converted into cash.

More specifically, the input unit 11 functions as a point purchasing unit 11a that purchases points to be used when receiving rental services, etc., a deposit point determination unit 11b that determines deposit points to be deposited to the business operator providing the rental service, etc. based on the total points purchased via the point purchasing unit 11a, a deposit period designation unit 11c that designates the deposit period for depositing the deposit points, and a provided service selection unit 11d that selects a desired rental service, etc. from at least one available and free rental service and so on, which are determined based on the deposit points and the deposit period.

Herein, the point purchasing unit 11a can purchase points to be used when receiving rental services, etc. from the business operator server 3 or purchase points issued by other operators (e.g., the digital currency issuing server 2) other than the business operator server 3 via an API (Application Programming Interface).

The business operator server 3 is a terminal such as a computer, which comprises an input unit 31 such as a keyboard that accepts input from the business operator a, a display unit 32 such as an LCD, a communication unit 33 that transmits and receives data with the terminal device 1, a deposit point storage unit 34 that stores deposit points deposited from the terminal device 1 via the communication unit 33, a provided service determination unit 35 that determines available toll-free rental services, etc., based on the deposit points and the deposit period in a case when receiving the deposit points and the deposit period from the terminal device 1 via the communication unit 33, a period management unit 36 that manages the period of the rental service, etc. used by the user of the terminal device 1, and a memory unit 37 that memorizes user information to which the rental service, etc. is provided.

Herein, in a case when the period of the rental service or the like used by the user has ended, the period management unit 36 notifies the terminal device 1 of the end of the period and returns the deposit points, which correspond to the user and have been deposited in the deposit point storage unit 34, to the terminal device 1. The communication unit 33 receives a processing request (HTTP request) from the user of the terminal device 1 via the HTTP protocol and sends a response. The data format of the HTTP request transmitted and received by the communication unit 33 is, for example, XML.

The memory unit 37 keeps a user management table 300 shown in FIG. 3. The user management table 300 shows information for each user of the toll-free system S, such as the ID, name, kana, romanized characters, password, deposit points, provided services, deposit period, and email address. Furthermore, the authentication process for the user by the business operator a can be performed by referring to the user management table 300.

### <Display of Terminal Device>

Next, examples of screen displays when a user of the terminal device 1 experiences a rental contract will be described with reference to FIGS. 4 to 8. In a case when logging in to the website provided by the business operator a using terminal device 1, a login screen may be displayed on the display of terminal device 1 and the user may access his/her personal page by entering a personal ID or a registered password.

First, the user of the terminal device 1 inputs his/her name 401 and purchase points 402 on the display 400 shown in FIG. 4 and presses a purchase button 403 to purchase points to be deposited when renting in advance. Herein, these points may be cashable points issued by the business operator a, the number of shares issued by the business operator a, or digital currency such as Bitcoin (registered trademark) issued via the digital currency issuing server 2.

Next, a user who wishes to use a rental service or the like from the business operator a visits the business operator a site shown in display 500 of FIG. 5 and inputs any of the deposit points 502 and the deposit period 503, based on the total points 501 owned by the user, and presses OK button 504 to notify the business operator a of the deposit points and the deposit period.

And then, as shown in display 600 of FIG. 6, the response 601 indicates the type of rental service and the like that can be used for free according to the deposit points and the deposit period from the business operator server 3, which is displayed on the display unit 12 of the terminal device 1. Then, the user of the terminal device I selects the desired rental service, etc. from the multiple rental services, etc. shown in the response 601 within the usage limit (multiple selections are possible in this case) via the input unit 11 and presses the decision button 602. Then, the user of the terminal device I receives the desired rental service or the like. Herein, if the amount of the deposit points is bigger, more valuable real estate such as a rental apartment and a rental service for a movable property such as home appliances are proposed in the response 601.

When the deposit period managed by the period management unit 36 of the business operator server 3 expires, the terminal device 1 of the user of the rental service receives a notice of the expiration of the rental period as shown in FIG. 7. Herein, “End of distribution service (701)” and “Return of item (702)” are displayed, and the deposit points are automatically returned.

Finally, in a case when the user selects the confirmation button 704 for “End of distribution service (701)” or “Return of item (702),” the points 801 that have been automatically returned from the business operator a to the user's terminal device 1 immediately after the deposit period ends and the current total points 802 are displayed, as shown in FIG. 8. It is also possible to extend the deposit period by selecting “Extend Deposit Period (703)” on the screen 700 shown in FIG. 7.

As mentioned above, the business operator a basically makes a profit by investing the funds, which have been received when points such as digital currency are purchased or the funds based on the deposited digital currency, into its own business or by managing them in stocks, etc. In this case, if the profits from these operations exceed the costs of the rental services, the business operator a can make profits. In that case, the business operator a will be able to provide various rental services to users free of charge. As a result, the toll-free system S can provide a free digital content distribution service and a free rental service for movable property and real estate.

On the other hand, a user of this toll-free system S can receive subscription services or rental services according to the deposit points free of charge for a specified period simply by purchasing cashable points and depositing them with the business operator a. At the same time, the user also certainly receives a refund of the cashable points when the contract period has elapsed. Therefore, the user will not be charged for services that are no longer needed.

### <Sequence Diagram>

Next, the overall sequence of the toll-free system S according to this embodiment will be explained with reference to FIG. 9. It should be noted that FIG. 9 is merely an example, and other sequences with different orders are also possible.

First, the user of the terminal device 1 purchases points from the business operator server 3 using a dedicated application or the like (S901). Then, the amount of points corresponding to the amount of the invested funds is given to the terminal device 1 (S902). It is noted that these points are points such as virtual currency that can be converted into cash.

Next, the user who wishes to use the toll-free system S determines the deposit points and the deposit period via the terminal device 1 (S903) and receives a response related to the available rental services and the like free of charge from the business operator server 3 according to the deposit points and the deposit period (S904).

Then, the user of the terminal device 1 determines a desired rental service or the like from among the responded services (S905). This figure shows a case where the user chooses a service from the content server 4, then the user is given a license for playing the content from the business operator server 3 (S906). The user of the terminal device 1 transmits the license to the content server 4 and plays the content (S907). After this, the user can play any content for free during the available period.

Next, in a case when the deposit period managed by the period management unit 36 of the business operator server 3 has ended, all of the deposit points done in S903 are automatically returned from the business operator server 3 to the terminal device 1. At the same time, a notice of expiration of the period is sent to the terminal device 1 (S909). Upon receiving this notice of expiration, the user notifies the confirmation notification, and at the same time, the content distribution is also terminated (S910).

Herein, the user of the terminal device 1 can then make a point selling request to the business operator server 3 at a desired time (S911). As a result, the user can receive a refund of the funds that is initially paid by the user (S912). During the period from S902 to S912, the business operator a makes a profit by investing funds in its own business or by investing in stocks or the like.

As mentioned above, the disclosure according to this embodiment is a toll-free system S comprising: a terminal device 1 that is owned by a user who receives the subscription and rental service; and a business operator server 3 that is connected to the terminal device via the Internet and is managed by a business operator who provides the toll-free subscription and rental service to the user. The terminal device 1 comprises: a transmitting/receiving unit 13 that transmits and receives data with the business operator server 3: a point purchasing unit 11a that purchases points to be used when receiving the subscription and rental service: a deposit point determination unit 11b that determines deposit points to be deposited with the business operator, which provides the subscription and rental service based on the total points purchased via the point purchasing unit 11a: a deposit period designation unit 11c that designates the deposit period for depositing the deposit points; and a provided service selection unit 11d that selects a desired subscription and rental service from at least one available toll-free subscription and rental services, which have been determined based on the deposit points and the deposit period. The business operator server 3 comprises: a communication unit 33 that communicates with the terminal device 1: a deposit point storage unit 34 that accumulates deposit points deposited from the terminal device via the communication unit 33: a provided service determination unit 35 that determines an available toll-free subscription and rental service based on the deposit points and deposit period in a case when receiving the deposit points and deposit period from the terminal device via the communication unit: a period management unit 36 that manages the period of the subscription and rental service, which is used by the user of the terminal device 1; and a memory unit 37 that stores user information to which the subscription and rental service is provided.

With this configuration, in terms of content distribution and other movable and immovable property rental services, a user of the toll-free system S can receive rental and distribution services for free. In addition, it is possible to appropriately prevent users from being charged for services that are no longer necessary. On the other hand, in the case where the business operator a is in an unreliable stage such as a start-up stage, they can obtain a large amount of funds as an effective fund-raising method.

In other words, the business operator server 3 identifies the products that can be rented from the registered products according to the deposit points and the deposit period designated by the user and returns that information onto the screen of the terminal device 1. Basically, the more the deposit points, the more products that can be used free of charge.

Furthermore, if the business operator a wishes to popularize the points or virtual currency issued by themselves, it can collaborate with any charged subscription services offered by other companies. This results in allowing users of those other companies' services to purchase and deposit points issued by the business operator a. This will make a subscription service, that was previously paid, for free, providing benefits to users while also hopefully increasing awareness and popularity of the company's currency.

Herein, the points returned by the business operator a to the user of terminal device 1 do not necessarily have to be the full amount of the deposit points, but may be returned at a rate according to the business performance of the business operator a. If it is not possible to refund the deposit points (digital currency) due to mismanagement by the business operator a, it is anticipated that a user-paid system will be in place, wherein the user may have a risk in said system. In addition, it is also possible that a collateral system in the form of stocks is one of the options, wherein the system may use assets owned by the company as the service according to the present disclosure or the business operator a as collateral. In this case, the total amount of the deposit money will be allocated to the stocks as each user's share.

It is to be noted that the present disclosure is not limited to the above-described embodiments and modified examples, and various modifications are possible within the spirit and scope of the present disclosure. Note that in order to achieve the above objectives as the toll-free system S, it is also possible to embody as the toll-free rental method that includes, as its steps, the characteristic units included in the toll-free system S and to embody as a program causing a computer to execute such steps. It should be also noted that such program can be distributed on a recording medium such as a USB and over a transmission medium such as the Internet.

### REFERENCE SIGNS LIST

S toll-free subscription and rental service system
1 terminal device
2 digital currency issuing server
3 business operator server
4 content server
5 rental business
11 input unit
11a point purchasing unit
11b deposit point determination unit
11c deposit period designation unit
11d provided service selection unit
12 display unit
13 transmitting/receiving unit
14 program execution unit
31 input unit
32 display unit
33 communication unit
34 deposit point storage unit
35 provided service determination unit
36 period management unit
37 memory unit

1. A toll-free subscription and rental service system comprising:
a terminal device that is associated with a user who receives a subscription and rental service; and
a business operator server that is connected to the terminal device via network and is managed by a business operator who provides the subscription and rental service to the user for free,
wherein the terminal device comprises:
a transmitting/receiving unit that transmits and receives data with the business operator server;
a point purchasing unit that purchases points to be used when receiving the subscription and rental service;
a deposit point determination unit that determines deposit points to be deposited to the business operator, which provides the subscription and rental service based on a total points purchased via the point purchasing unit;
a deposit period designation unit that designates the deposit period for depositing the deposit points; and
a provided service selection unit that selects a desired subscription and rental service from at least one available toll-free subscription and rental services, which have been determined based on the deposit points and the deposit period,
wherein the business operator server comprises:
a communication unit that communicates with the terminal device;
a deposit point storage unit that stores deposit points deposited from the terminal device via the communication unit;
a provided service determination unit that determines an available toll-free subscription and rental service based on the deposit points and the deposit period in a case when receiving the deposit points and the deposit period from the terminal device via the communication unit;
a period management unit that manages the period of the subscription and rental service, which is used by the user of the terminal device; and
a memory unit that memorizes user information to which the subscription and rental service is provided.

2. The toll-free subscription and rental service system according to claim 1, wherein the period management unit returns the deposit points, which correspond to the user and have been deposited in the deposit point storage unit, to the terminal device, in a case when the period of the subscription and rental service used by the user has ended.

3. The toll-free subscription and rental service system according to claim 1, wherein the memory unit memorizes information relating to name, password, the deposit points, provided services, and the deposit period of each user who uses the toll-free subscription and rental service.

4. The toll-free subscription and rental service system according to claim 1, wherein the deposit point is a point or virtual currency that is provided by the business operator to the user of the terminal device.

5. The toll-free subscription and rental service system according to claim 1, wherein the rental service includes a digital content distribution service and a rental service such as movable and immovable properties; and
wherein the subscription service includes an offering of a designated service or designated consumer goods in exchange for paying a fixed amount at a fixed interval.

6-9. (canceled)

10. The toll-free subscription and rental service system according to claim 2, wherein the memory unit memorizes information relating to name, password, the deposit points, provided services, and the deposit period of each user who uses the toll-free subscription and rental service.

11. The toll-free subscription and rental service system according to claim 2, wherein the deposit point is a point or virtual currency that is provided by the business operator to the user of the terminal device.

12. The toll-free subscription and rental service system according to claim 3, wherein the deposit point is a point or virtual currency that is provided by the business operator to the user of the terminal device.

13. The toll-free subscription and rental service system according to claim 2, wherein:
the rental service includes a digital content distribution service and a rental service such as movable and immovable properties; and
the subscription service includes an offering of a designated service or designated consumer goods in exchange for paying a fixed amount at a fixed interval.

14. The toll-free subscription and rental service system according to claim 3, wherein:
the rental service includes a digital content distribution service and a rental service such as movable and immovable properties; and
the subscription service includes an offering of a designated service or designated consumer goods in exchange for paying a fixed amount at a fixed interval.

15. The toll-free subscription and rental service system according to claim 4, wherein:
the rental service includes a digital content distribution service and a rental service such as movable and immovable properties; and
the subscription service includes an offering of a designated service or designated consumer goods in exchange for paying a fixed amount at a fixed interval.

16. A non-transitory computer-readable storage medium having program instructions thereon that, when executed by at least one hardware processor of a terminal device associated with a user who receives a toll-free subscription and rental service, direct the terminal device to perform a method comprising:
transmitting and receiving data with a business operator server that provides the subscription and rental service;
purchasing points to be used when receiving the subscription and rental service;
determining deposit points to be deposited to the business operator, which provides the rental service based on a total points purchased via the point purchasing step;
designating a deposit period for depositing the deposit points; and
selecting a desired subscription and rental service from at least one available toll-free subscription and rental services, which have been determined based on the deposit points and the deposit period.

17. A system, comprising:
a device comprising at least one hardware processor managed by a business operator; and
memory having program instructions stored thereon that, when executed by the at least one hardware processor, direct the device to perform a method comprising:
providing a toll-free subscription and rental service to a user, while connecting with a terminal device via a network;
communicating with the terminal device;
storing deposit points deposited from the terminal device during communication with the terminal device;
determining an available toll-free subscription and rental service based on the deposit points and a deposit period, in a case when receiving the deposit points and the deposit period from the terminal device when communicating with the terminal device;
managing a period of the subscription and rental service, which is used by the user of the terminal device; and
memorizing user information to which the subscription and rental service is provided.
